(19) United States
(12) Patent Application Publication
(10) Pub. No.: US 2002/0056034 A1
(43) Pub. Date: May 9, 2002

(54) MECHANISM AND METHOD FOR PIPELINE CONTROL IN A PROCESSOR

(76) Inventors: MARGARET GEARTY, BRISTOL (GB); CHIH-JUI PENG, SAN JOSE, CA (US)

Correspondence Address: TOWNSEND AND TOWNSEND AND CREW LLP, TWO EMBARCADERO CENTER, 8TH FLOOR, SAN FRANCISCO, CA, 94111-3834, US

(21) Appl. No.: 09/410,773

(22) Filed: Oct. 1, 1999

(51) Int. Cl. G06F 15/00

(52) U.S. Cl. 712/23; 712/217

(57) ABSTRACT

A data processing system including a memory system and a plurality of peripheral components. A processor is coupled to the memory and peripheral components. A plurality of pipeline stages are implemented within the processor where each stage is configured to perform specific operations according to instructions then associated with that stage. A snapshot register is associated with at least some of the pipeline stages where the snapshot register configured to store data describing the state of execution of the instruction then associated with that stage.

### BACKGROUND OF THE INVENTION

1. Field of the Invention

The present invention relates in general to microprocessors and, more particularly, to a system, method, and mechanism providing pipeline control in a pipelined data processor.

2. Relevant Background

Computer programs comprise a series of instructions that direct a data processing mechanism to perform specific operations on data. These operations including loading data from memory, storing data to memory, adding, multiplying, and the like. Data processors, including microprocessors, microcontrollers, and the like include a central processing unit (CPU) comprising one or more functional units that perform various tasks. Typical functional units include a decoder, an instruction cache, a data cache, an integer execution unit, a floating point execution unit, a load/store unit, and the like. A given program may run on a variety of data processing hardware.

Early data processors executed only one instruction at a time. Each instruction was executed to completion before execution of a subsequent instruction was begun. Each instruction typically requires a number of data processing operations and involves multiple functional units within the processor. Hence, an instruction may consume several clock cycles to complete. In serially executed processors, each functional unit may be busy during only one step, and idle during the other steps. The serial execution of instructions results in the completion of less than one instruction per clock cycle.

As used herein, the term “data processor” includes complex instruction set computers (CISC), reduced instruction set computers (RISC) and hybrids. A data processor may be a stand alone central processing unit (CPU) or an embedded system comprising a processor core integrated with other components to form a special purpose data processing machine. The term “data” refers to a digital or binary information that may represent memory addresses, data, instructions, or the like.

In response to the need for improved performance, several techniques have been used to extend the capabilities of these early processors including pipelining, superpipelining, and superscaling. Pipelined architectures attempt to keep all the functional units of a processor busy at all times by overlapping execution of several instructions. Pipelined designs increase the rate at which instructions can be executed by allowing a new instruction to begin execution before a previous instruction is finished executing. A simple pipeline may have only five stages, whereas an extended pipeline may have ten or more stages. In this manner, the pipeline hides the latency associated with the execution of any particular instruction.

The goal of pipeline processors is to execute multiple instructions per cycle (IPC). Due to pipeline hazards, actual throughput is reduced. Pipeline hazards include structural hazards, data hazards, and control hazards. Structural hazards arise when more than one instruction in the pipeline requires a particular hardware resource at the same time (e.g., two execution units requiring access to a single ALU resource in the same clock cycle). Data hazards arise when an instruction needs as input the output of an instruction that has not yet produced that output. Control hazards arise when an instruction changes the program counter (PC) because execution cannot continue until the target instruction from the new PC is fetched.

When hazards occur, the processor must stall or place “bubbles” (e.g., NOPs) in the pipeline until the hazard condition is resolved. This increases latency and decreases instruction throughput. As pipelines become longer, the likelihood of hazards increases. Hence, an effective mechanism for handling hazard conditions is important to achieving the benefits of deeper pipelines.

Another goal of many processors is to control the power used by the processor. Many applications, particularly those directed at mobile or battery operated environments, require low power usage. The execution pipelines of a computer consume a significant amount of power. Power consumption is largely caused by moving data between registers, files, and execution units. As data paths become wider, the power consumed to move the data increases.

Hence, in order to execute instructions efficiently at a high throughput within a pipeline it is important to coordinate and control the flow of instructions, operations, and data within the execution pipeline. The order and manner in which the operands and results of these instructions are made available to each other within the execution pipeline is of critical importance to the throughput of the pipeline.

### SUMMARY OF THE INVENTION

The present invention involves a data processing system including a memory system and a plurality of peripheral components. A processor is coupled to the memory and peripheral components. A plurality of pipeline stages are implemented within the processor where each stage is configured to perform specific operations according to instructions then associated with that stage. A snapshot register is associated with at least some of the pipeline stages where the snapshot register is configured to store data describing the state of execution of the instruction then associated with that stage.

The present invention also involves a system and method of operating a data processor having an execution pipeline with a plurality of stages. Each stage has a plurality of operational modes. For each stage instruction metadata is stored in a snapshot register, where the instruction metadata describes an instruction within the associated stage. The snapshot register contents are made available to a number of pipeline stages. During operation of the pipeline stages, the snapshot register is accessed to view the instruction metadata pertaining to each stage. The operational mode of each pipeline stage is determined at least in part based upon the contents of the snapshot register.

The foregoing and other features, utilities and advantages of the invention will be apparent from the following more particular description of a preferred embodiment of the invention as illustrated in the accompanying drawings

### BRIEF DESCRIPTION OF THE DRAWINGS

FIG. 1 shows in block diagram form a computer system incorporating an apparatus and system in accordance with the present invention;

FIG. 2 shows a processor in block diagram form incorporating the apparatus and method in accordance with the present invention;

FIG. 3 illustrates a CPU core useful in the implementation of the processor and system shown in FIG. 1 and FIG. 2 in accordance with the present invention;

FIG. 4 shows an instruction fetch unit in which features of the present invention are embodied in a particular implementation;

FIG. 5 illustrates an exemplary execution pipeline in accordance with a specific embodiment of the present invention;

FIG. 6 illustrates comparative pipeline timing for the execution pipeline shown in FIG. 5;

FIG. 7A and FIG. 7B show exemplary a snapshot register entries in accordance with embodiments of the present invention; and

FIG. 8 shows an operand multiplexing mechanism in accordance with an embodiment of the present invention.

### DETAILED DESCRIPTION OF THE PREFERRED EMBODIMENTS

The present invention involves controlling a pipeline in a pipeline data processor such as an embedded processor, a microprocessor, or microcontroller. Pipeline control includes a diverse range of operations that generally affect the efficiency and throughput of an instruction execution pipeline. In particular, pipeline control is used to detect and avert hazard conditions that might stall or slow the pipeline, configure data paths to forwards operands efficiently amongst execution units, handle exception conditions efficiently and precisely, and similar control operations.

The present invention uses a snapshot file that comprises a repository for metadata describing the instructions currently within a pipeline of the pipeline data processor. The snapshot file communicates with a centralized pipeline control mechanism. The pipeline control mechanism uses the metadata in a variety of ways to provide efficient control over a wide range of functions using a common set of control techniques and control hardware.

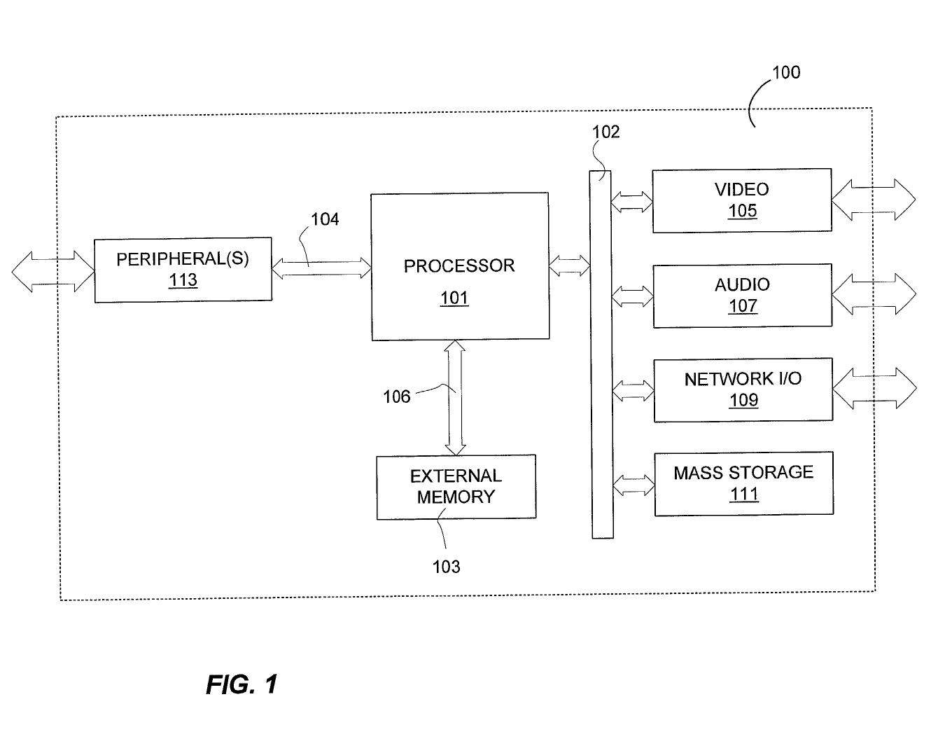

Any system is usefully described as a collection of processes or modules communicating via data objects or messages as shown in FIG. 1. The modules may be large collections of circuitry whose properties are somewhat loosely defined, and may vary in size or composition significantly. The data object or message is a communication between modules that make up the system. To actually connect a module within the system, an interface is defined between the system and the component module.

The present invention is illustrated in terms of a media system 100 shown in FIG. 1. Media processor 100 comprises, for example, a “set-top box” for video processing, a video game controller, a digital video disk (DVD) player, and the like. Essentially, system 100 is a special purpose data processing system targeted at high throughput multimedia applications. Features of the present invention are embodied in processor 101 that operates to communicate and process data received through a high speed bus 102, peripheral bus 104, and memory bus 106.

Video controller 105 receives digital data from system bus 102 and generates video signals to display information on an external video monitor, television set, and the like. The generated video signals may be analog or digital. Optionally, video controller may receive analog and/or digital video signals from external devices as well. Audio controller 107 operates in a manner akin to video controller 105, but differs in that it controls audio information rather than video.

Network I/O controller 109 may be a conventional network card, ISDN channel, modem, and the like for communicating digital information. Mass storage device 111 coupled to high speed bus 102 may comprise magnetic disks, tape drives, CDROM, DVD, banks of random access memory, and the like. A wide variety of random access and read only memory technologies are available and are equivalent for purposes of the present invention. Mass storage 111 may include computer programs and data stored therein. In a particular example, high speed bus 102 is implemented as a peripheral component highway (PCH)/peripheral component interconnect (PCI) industry standard bus. An advantage of using an industry standard bus is that a wide variety of expansion units such as controller's 105, 107, 109 and 111 are readily available.

Peripherals 113 include a variety of general purpose I/O devices that may require lower bandwidth communication than provided by high speed bus 102. Typical I/O devices include read only memory (ROM) devices such as game program cartridges, serial input devices such as a mouse or joystick, keyboards, and the like. Processor 101 includes corresponding serial port(s), parallel port(s), printer ports, and external timer ports to communicate with peripherals 113. Additionally, ports may be included to support communication with on-board ROM, such as a BIOS ROM, integrated with processor 101. External memory 103 is typically required to provide working storage for processor 101 and may be implemented using dynamic or static RAM, ROM, synchronous DRAM, or any of a wide variety of equivalent devices capable of storing digital data in a manner accessible to processor 101.

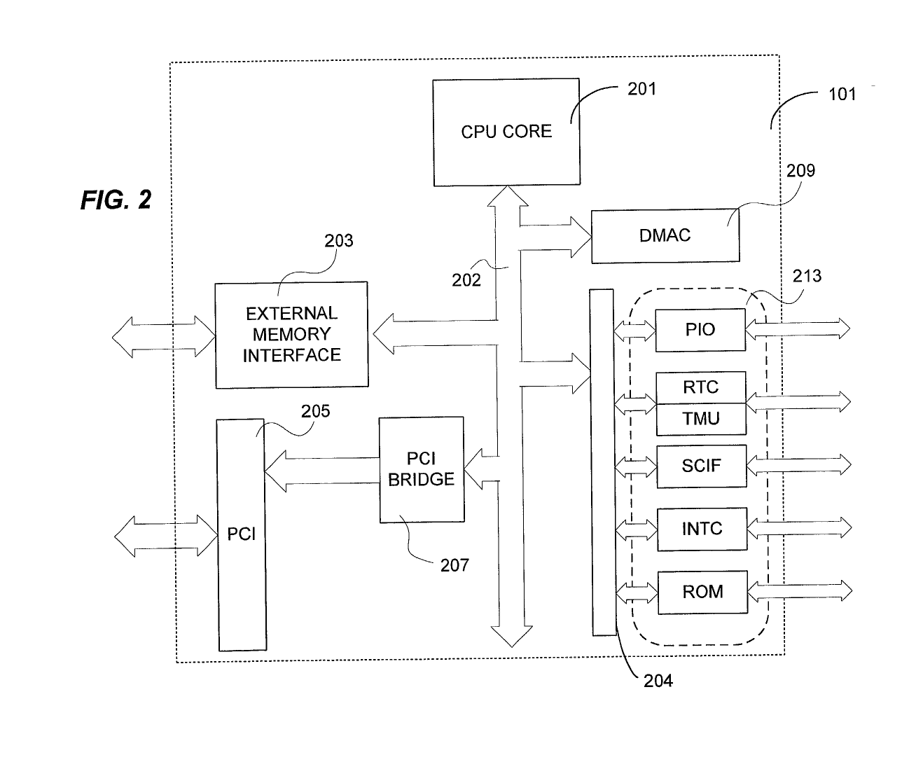

Processor 101 is illustrated in a greater detail in the functional diagram of FIG. 2. One module in a data processing system is a central processor unit (CPU) core 201. The CPU core 201 includes, among other components execution resources (e.g., arithmetic logic units, registers, control logic) and cache memory. These functional units, discussed in greater detail below, perform the functions of fetching instructions and data from memory, preprocessing fetched instructions, scheduling instructions to be executed, executing the instructions, managing memory transactions, and interfacing with external circuitry and devices.

CPU core 201 communicates with other components shown in FIG. 2 through a system bus 202. In the preferred implementation system bus 202 is a high-speed network bus using packet technology and is referred to herein as a “super highway”. Bus 202 couples to a variety of system components. Of particular importance are components that implement interfaces with external hardware such as external memory interface unit 203, PCI bridge 207, and peripheral bus 204.

The organization of interconnects in the system illustrated in FIG. 2 is guided by the principle of optimizing each interconnect for its specific purpose The bus system 202 interconnect facilitates the integration of several different types of sub-systems. It is used for closely coupled subsystems which have stringent memory latency/bandwidth requirements. The peripheral subsystem bus 204 supports bus standards which allow easy integration of hardware of types indicated in reference to FIG. 1 through interface ports 213. PCI bridge 207 provides a standard interface that supports expansion using a variety of PCI standard devices that demand higher performance that available through peripheral port 204. The system bus 202 may be outfitted with an expansion port which supports the rapid integration of application modules without changing the other components of system 101. External memory interface 203 provides an interface between the system bus 202 and the external main memory subsystem 103 (shown in FIG. 1). The external memory interface comprises a port to system bus 202 and a DRAM controller.

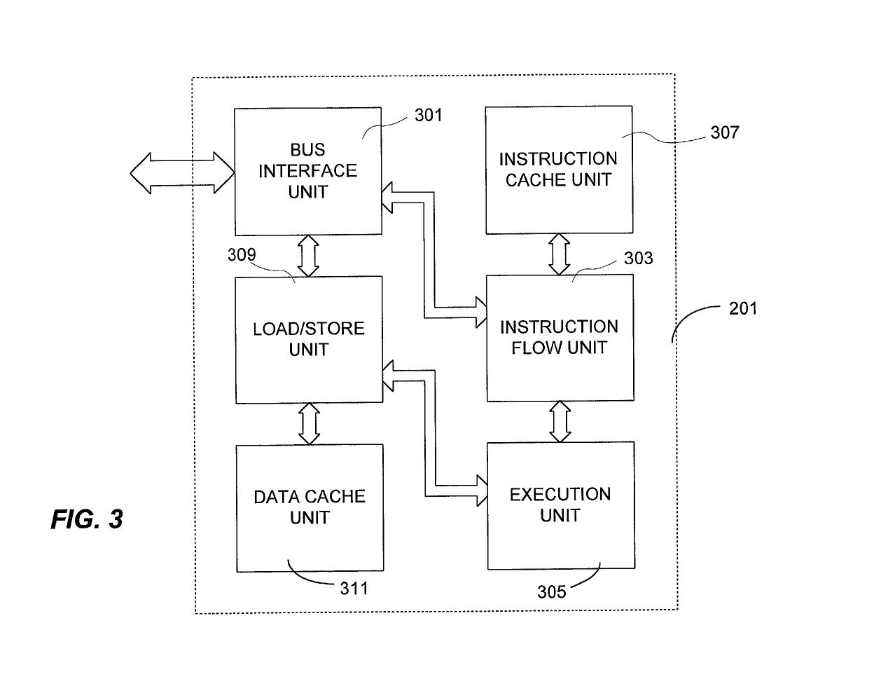

The CPU core 201 can be represented as a collection of interacting functional units as shown in FIG. 3. These functional units, discussed in greater detail below, perform the functions of fetching instructions and data from memory, preprocessing fetched instructions, scheduling instructions to be executed, executing the instructions, managing memory transactions, and interfacing with external circuitry and devices.

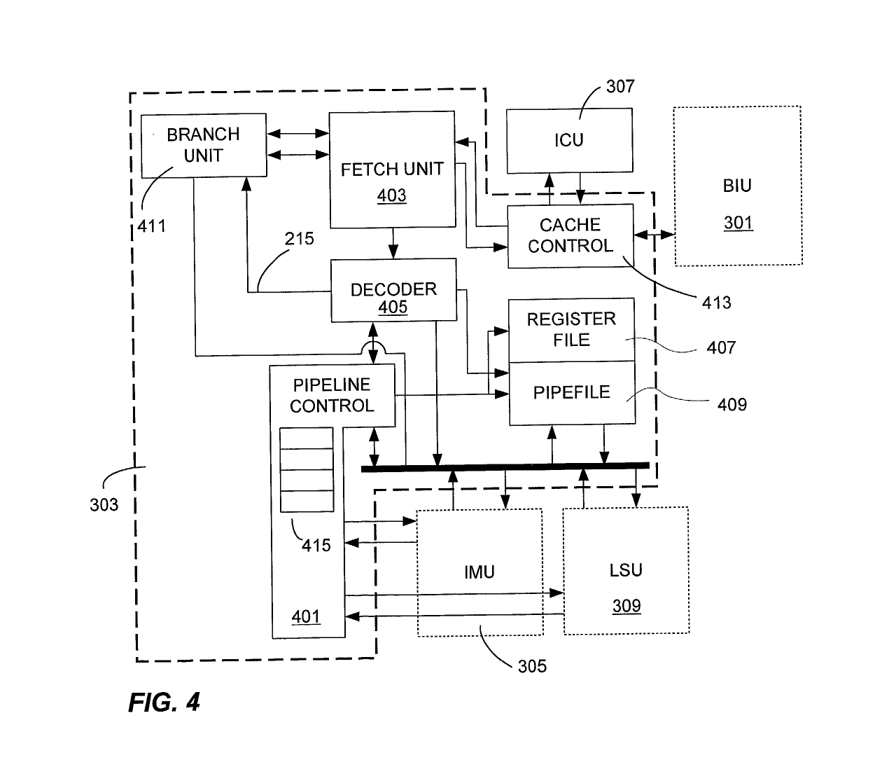

A bus interface unit (BIU) 301 handles all requests to and from the system bus 202 and external memory. An instruction flow unit (IFU) 303 is the front end of the CPU pipe and controls fetch, predecode, decode, issue and branch operations in the preferred embodiment. In accordance with the preferred embodiment, IFU 303 includes a pipe control unit 401 (shown in FIG. 4) that implements features of the present invention. However, it is contemplated that the inventive features of the present invention may be usefully embodied in a number of alternative processor architectures that will benefit from the performance features of the present invention. Accordingly, these alternative embodiments are equivalent to the particular embodiments shown and described herein.

An instruction execution unit (IEU) 305 handles all integer and multimedia instructions. The main CPU datapath includes an instruction cache unit (ICU) 307 implements an instruction cache (Icache not shown) and an instruction translation lookaside buffer (ITLB, not shown). Load store unit (LSU) 309 handles all memory instructions. A data cache control unit (DCU) 311 includes a data cache (Dcache, not shown) and a data translation lookaside buffer (DTLB, not shown). Although the present invention preferably uses separate data and instruction caches, it is contemplated that a unified cache can be used with some decrease in performance. In a typical embodiment, the functional units shown in FIG. 2, and some or all of cache memory 105 may be integrated in a single integrated circuit, although the specific components and integration density are a matter of design choice selected to meet the needs of a particular application. Additional functional units may be readily incorporated in CPU core 201 such as a floating point execution unit (not shown) optimized for processing floating point instructions or a special purpose graphics unit optimized for processing graphics instructions.

FIG. 4 shows hardware resources within IFU 303 including a pipe control unit 401 in accordance with the present invention. FIG. 4 shows a simplified IFU block diagram with the internal blocks as well as the external interfacing units. IFU 303 is indicated with a bold dashed line whereas external interfacing units are indicated in dashed-line boxes. As shown in FIG. 4, IFU 303 can be divided into the following functional blocks according to their functions: an instruction cache control unit (ICC) 413, a fetch unit (FE) 403, a branch unit (BR) 411, a decode unit 405, a pipe control unit 401, and an operand file unit comprising register file 407 and pipe file 409.

IFU 303 functions as the sequencer of CPU core 201 in accordance with the present invention. It coordinates the flow of instructions and data within the core 201 as well as merges the external events with the core internal activities. Its main functions are to fetch instructions from ICU 307 using fetch unit 403 and decode the instructions in decoder 405. IFU 303 checks for instruction inter-dependency, reads the operands from the register file 407 and sends the decoded instructions and the operands to the execution units (e.g., IEU 305, and LSU 309). In addition, IFU 303 couples to BIU 301 on instruction cache misses to fill the instruction cache within ICU 307 with the missing instructions from external memory.

Because of its sequencing role within the CPU core 201, IFU 303 interfaces with almost every other functional unit. The interface between IFU 303 and BIU 301 initiates the loading of instructions into the instruction cache. The interface between IFU 303 and ICU 307 provides the flow of instructions for execution. The interface between IFU 303 and IMU 305 and LSU 309 provides the paths for sending/receiving instructions, operands, results, as well as the control signals to enable the execution of instructions. In addition to these interfaces, IFU 303 may also receive external interrupt signals from an external interrupt controller (shown in FIG. 2), which samples and arbitrates external interrupts. IFU 303 will then arbitrate the external interrupts with internal exceptions and activates the appropriate handler to take care of the asynchronous events. Pipe file 409 operates to collect interim results from the execution units, and writes them back to the register file 407 when the instruction is completed.

Once instructions are decoded, pipe control unit 401 monitors their execution through the remaining pipe stages. The main function of pipe control unit 401 is to ensure that instructions are executed smoothly and correctly that (i) instructions will be held in the decode stage until the source operands are ready or can be ready when needed, (ii) that synchronization and serialization requirements imposed by the instruction as well as internal/external events are observed, and (iii) that data operands and interim results are forwarded correctly. An important hardware resource in accordance with the present invention is snapshot file 415 within pipeline control unit 410. Snapshot file 415 includes a plurality of entries, described in greater detail hereinafter, with each entry holding metadata about instructions currently executing in the pipeline. Snapshot registers 415 communicate directly with pipeline control unit 401, but the metadata contained in snapshot registers 415 is used to control operation of a wide variety of pipeline execution resources.

To simplify the pipe control logic, the pipe control unit 401 makes several observations and assumptions with respect to instruction execution. One of the assumptions is that none of IEU 305 instructions can cause exception that will interrupt the pipeline and all of them flow through the pipe stages deterministically. This assumption allows the pipe control unit 401 to view IEU 305 as a complex data operation engine that does not need to know where the input operands are coming from and where the output results are going to. All the data forwarding and hazard detection logic can then be lumped into the pipe control unit 401 using a comparatively simple mechanism. To accommodate for the non-deterministic operations in the LSU 309, some modifications are then made to this simple mechanism. The modifications, however, are specifically targeted at the idiosyncrasies of the LSU pipeline, and should cause minimal overhead.

Another major function of the pipe control unit 401 is to handle non-sequential events such as instruction exceptions, external interrupts, resets, etc. Under normal execution condition, this part of the pipe control unit 401 is always in the idle state. It wakes up when an event occurs. The pipe control unit 401 receives the external interrupt/reset signals from the external interrupt controller (shown in FIG. 2). It receives internal exceptions from many parts of the CPU core 201. In either case, the pipe control unit 401 will clean up the pipeline, and then informs the branch unit 411 to save the core state and branches to the appropriate handler. When multiple exceptions and interrupt occur simultaneously, the pipe control unit 401 arbitrates between them according to the architecturally defined priority. The pipe control unit 401 also looks at internal configuration and control registers to determine whether and when an interrupt or exception should be blocked.

The operand file unit implements the architecturally defined general purpose register file 407. In addition, it also implements a limited version of a reorder buffer called “pipe file” 409 for storing and forwarding interim results that are yet to be committed to architectural registers. Because CPU core 201 is principally directed at in-order execution, there is only a small window of time that execution results may be produced out-of-order. The present invention takes advantage of this property and implements a simplified version of the reorder buffer that allows interim results to be forwarded as soon as they are produced, while avoiding the expensive tag passing/matching mechanism usually associated with a reorder buffer. The operand file implements the data path portion of this pipe file. The control is implemented in the pipe control unit 401.

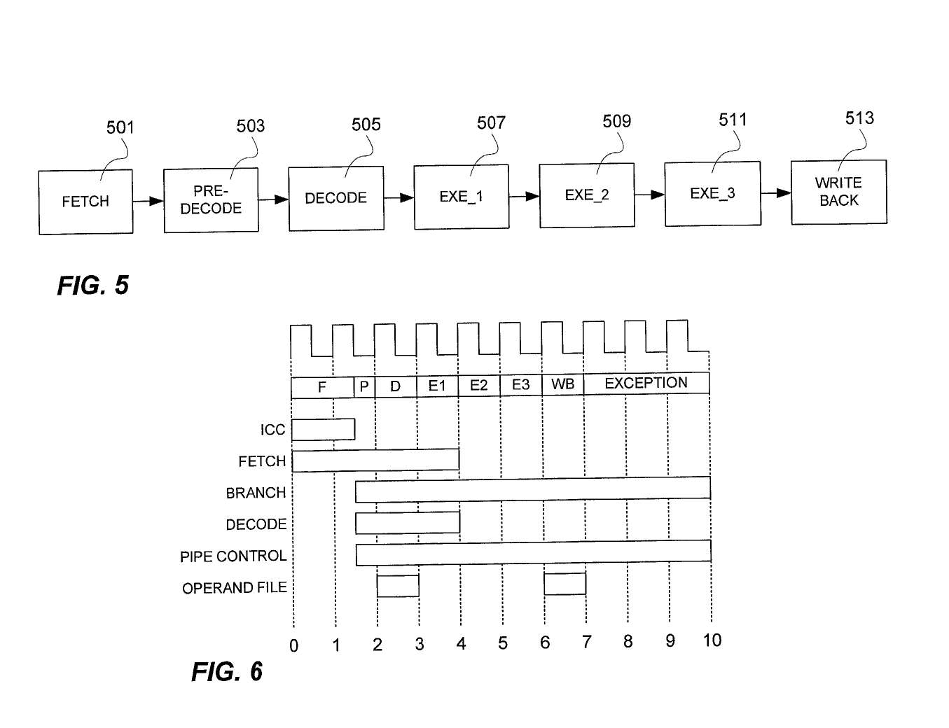

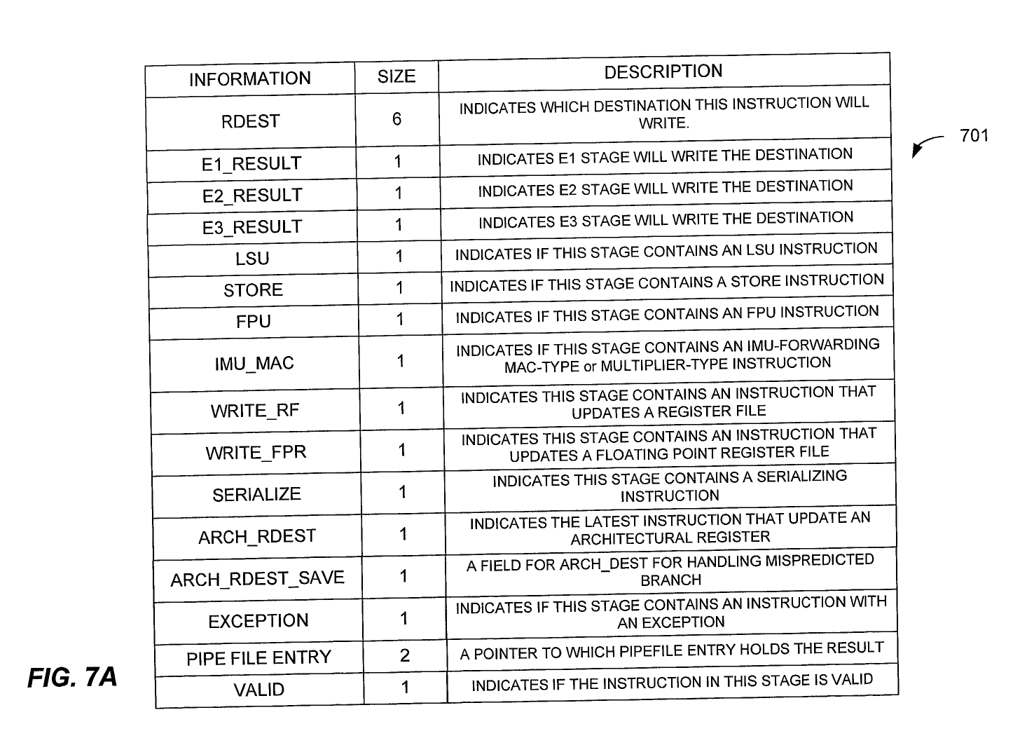

FIG. 5 and FIG. 6 illustrate an example execution pipeline in accordance with the present invention. The particular example is a scalar (i.e., single pipeline), single issue machine. The implementation in FIG. 5 and FIG. 6 includes three execution stages. Many instructions however execute in a single cycle. The present invention implements features to enable comprehensive forwarding within the pipeline to achieve a high instruction throughput.

The general operation of each pipeline stage is described below, however, it is important to understand that the behavior of each pipeline stage may be altered depending on the instructions within that pipeline stage and the other instructions with other pipeline stages. Controlling this alterable behavior is an important feature of the present invention. For example, the decoder stage can choose to issue or withhold issue of an instruction to subsequent pipeline stages. An execution stage can choose which sources are used to obtain source operands and destination registers for its operations. A write back stage can select whether to actually commit results to an architectural register. The pipeline control mechanism, including the snapshot register 415, is used to implement these operational mode selections.

In the pre-decode stage 503 the instruction cache access which was initiated in the previous cycle is completed and the instruction is returned to IFU 303 where it can be latched by mid-cycle. An instruction may spend from 1 to n cycles in stage 503 depending on downstream pipeline instructions. In the second half of stage 503, some pre-decoding of the instruction will be carried out. Decode stage 505 handles the full instruction decode, operand dependency checks and register file read and instruction issue to the execution units.

The first execution stage 507 implements the execution of all single cycle integer instructions as well as the address calculation for memory and branch instructions. The second execution stage 509 implements the second cycle of execution for all multicycle integer/multimedia instructions. Additionally it corresponds to the second cycle for load instructions. The third execution stage 511 implements the third cycle of execution for all multicycle integer/multimedia instructions and corresponds to the completion cycle for load instructions. Write back stage 513 is where all architectural state modified by an instruction (e.g. general purpose register, program counter etc.) is updated. The exception status of the instruction arriving in this stage or any external exception can prevent the update in this stage.

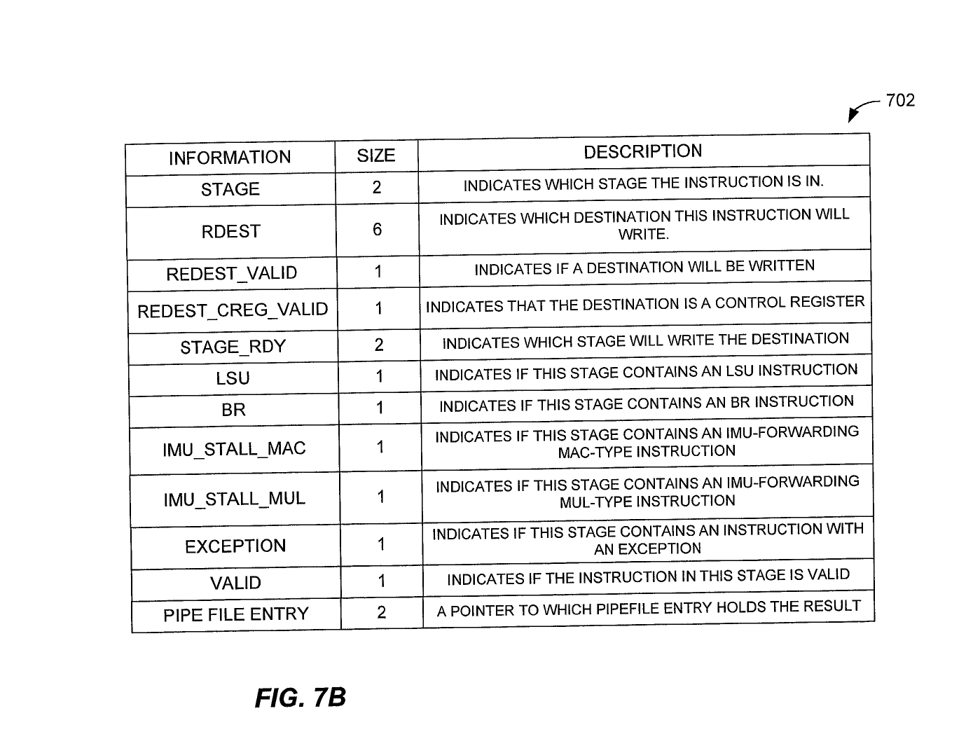

The pipe control unit 401 performs a number of operations in handling the instruction flow. An important feature of the pipe control unit 401 is the pipeline snapshot file 415 (shown in FIG. 4) implemented within pipe control unit 401. Snapshot file 415 may be implemented as a lookup table having a table entry 701 (shown in FIG. 7) corresponding to each execution stage in the pipeline. The snapshot file 415 provides a central resource for all pipeline control operations such as dependency checks, operand forwarding, exception handling, and the like. In a particular implementation, snapshot file 415 includes four entries corresponding to the three execution pipeline stages and the write back pipeline stage.

FIG. 7A and FIG. 7B show exemplary snapshot files 701 and 702 indicating entries holding metadata describing the instruction execution state at the corresponding pipe stage. As instructions move from one stage to another, their associated snapshot entry moves to the corresponding snapshot entry 701 or 702. The contents of each snapshot entry 701 may be varied to meet the needs of a particular application. The specific examples shown in FIG. 7 correspond to pipeline control operations described hereinbelow. The essential functionality of examples 701 and 702 are similar although the implementation of that essential functionality differs between the examples. In comparing the examples, snapshot file 701 does not include a “STAGE” entry as that is implied by the index of the entry whereas example 702 includes an explicit STAGE entry. The single STAGE_RDY entry of FIG. 7B is implemented using three separate entries (E1_RESULT, E2_RESULT and E3_RESULT) in the example of FIG. 7A. The fields have the function generally described in the figures and additional or fewer fields may be added to meet the needs of a particular application.

In the particular example, the data in each entry 701, particularly the valid and exception bits, can be updated each cycled by the pipe control unit 401 to maintain an accurate snapshot. The valid bit indicates if the instruction in the associated stage is valid whereas the exception bit indicates whether the instruction in the associated execution stage has incurred an exception condition during execution. In either case the data is not ordinarily committed to architectural state. In other words, the writeback stage 513 operation will be suppressed in response to the valid and exception fields.

In operation, the snapshot register may be used by the pipeline control unit 401 to perform a number of parallel checks to classify the instruction currently being processed by the decoder 405. For example, the three potential operand register fields of the instruction word are checked against the existing pipe snapshot to detect data dependency, forwarding dependence, write-after-write hazard, and write-after-write for an accumulating-type instruction.

Data dependency checking is performed by comparing the operand register specifiers of the instruction in decode against the register destinations marked to be written by each subsequent pipeline stage. If there is a match and the data will not be ready in this stage, then a true data dependency exists. This data dependency is resolved by, for example, stalling the instruction currently within the decode stage. Similarly, forwarding dependency checking is performed by comparing Rdest to determine when the result upon which the decoder instruction depends will be ready. If the result is ready in the same matched stage that the dependent instruction needs it, the result can be forwarded from the result bus. If the result is ready in a previous stage it can be forwarded from the pipefile.

A write after write hazard is indicated when an operand register specifier matches on more than one entry. In this case, the dependency can be resolved if the data can be forwarded from the correct (i.e., earlier) conflicting pipeline stage. Accordingly, pipe control can determine to control the forwarding from the earlier stage which matches.

When there is an instruction of the IMU-internal forwarding class (e.g., an accumulating-type instruction) in the first or second execution stages 507 or 509, the register destination of this instruction is checked against the register destination of an earlier instruction in the third execution stage 511. If a match is found and the instruction in the third execution stage 511 is of the same class, the pipe control unit 401 will generate the proper internal forwarding select signals to forward the third stage result to the first or second stage 507 or 509.

For a hazard to actually be detected one of the source registers of the instruction must be valid and must match against a valid register destination in the snapshot file. Hazard detection of the preferred implementation only detects general purpose register dependencies. Though the snapshot file also stores control register destinations, these are not marked as valid and therefore do not show up in the dependency checks. However, it is contemplated that with the addition of additional fields to the snapshot file such control register dependency checking could be implemented.

Under normal conditions once an instruction has been issued to an execution unit its entry will progress through each stage of the snapshot file on each clock edge. At the beginning of each execution stage the control for writing the result to the pipefile is generated. This is determined based on a comparison of the current execution stage with the stage_rdy fields of the execution stage entry in the snapshot file. Even if the associated “rdest_valid” indicates the destination register is invalid, the value is written to the pipefile nonetheless. This is to allow transportation of data for exceptions back to the branch unit. Once an instruction reaches write-back, the rdest_valid field also determines if the contents of the pipefile is written back to the architectural register file. Once in write-back, if no exception has occurred, the instruction has completed.

The contents of snapshot register 415 can be changed dynamically for instructions in the pipeline by altering, for example, the “exception” or “valid” fields. In a particular implementation, any functional unit that detects an invalidating or exception condition can assert control signals that change a particular snapshot file entry's state from valid to invalid. This will be done, for example, when a data dependency is detected by the pipeline control unit 401. Similarly, the pipe control unit 401 can stall the instruction currently in decode stage 503 whenever a condition is detected that indicates a reason for the instruction not to proceed down the pipeline (i.e., a serialized instruction or data hazard). The exception field indicates only a binary condition that an exception exists or does not. Information about the type of exception is held elsewhere in pipeline control unit 401.

Though exceptions are only handled and launched in write-back, they can be detected at any point in the pipeline. The behavior of pipeline control unit 401 on exception detection depends on where the exception is detected. In all cases, the associated stage of the pipeline snapshot file is updated with the exception bit so that on reaching write-back the launch sequence can be initiated.

Fetch stage exceptions, sometimes referred to as front end traps, are detected in the fetch stage these are only notified to the pipeline controller 401 when they reach decode. Thus the treatment of these exceptions is identical to decode stage exceptions. Decode stage exceptions cause the decode stage to indicate that the current instruction has an exception to the pipeline control unit 401. This causes the pipeline control unit to mark that instruction as excepting in the snapshot entry 701 associated with that instruction and to carry out a control sequence (e.g., back-serialization of the excepting instruction).

The snapshot register plays a role in managing pipefile 409 and operand file 407 updates in the event of exceptions. Even though an exception has been detected the pipefile 409 will continue to be updated with data according to the “stage_rdy” field of the snapshot file. While an excepting instruction is executing through the pipe, in certain cases the result data associated with the excepting data is of interest. A key point is that these results are written to pipefile 409 in the normal stage_rdy stage of the excepting instruction. As long as this rule is honored exception data is transported through the pipefile 409 as normal and will indicate to the branch unit 411 at write-back that exception data of interest is on the write-back bus.

To allow the execution of excepting instructions to be identical to non-excepting instructions the following generalizations of pipefile handling are implemented. First, all load/store instructions, even if they return no result normally (such as stores) have the “stage_rdy” indicator in the pipeline snapshot file marked as EXE_3 stage 509. Pipeline control unit 401 will thus use the normal mechanism to validate data in the pipefile. All excepting instructions detected at or before decode stage 503 have the “stage_rdy” indicator marked as EXE_1 stage 507. Thus, the result data from EXE_1 will be marked as valid in the pipefile. In both cases, even though the data in the pipefile is marked as valid, write back-suppression will prevent it being written into the register file and incorrectly modifying architectural state.

Another general utility of the snapshot register is in handling internal operand forwarding within the pipeline. Because the snapshot entry 701 indicates which pipe stage will produce a result to the pipefile 409, subsequent instructions can reliably use the interim result from the pipefile 409 before it is committed to architectural state. This process is called internal operand forwarding.

When decode indicates that it has a valid instruction the pipe control block determines from the instruction code the source of the operands for the instruction. The operand can be sourced from, for example:

Register operands;

Indirectly forwarded operands through the three pipefile entries;

Directly forwarded operands from the result busses;

The extended immediate field from the instruction;

The program counter;

The contents of an instruction address register (IAR);

The contents of a control register; and

A tied low constant field;

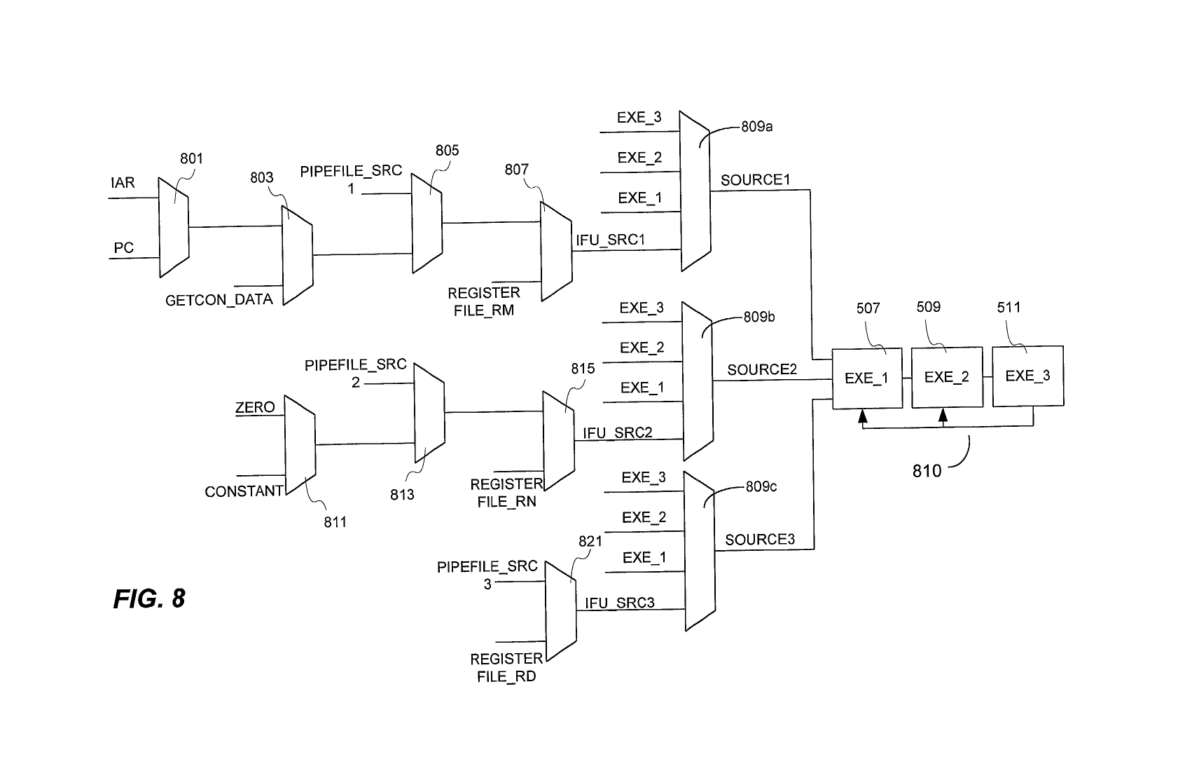

The above gives up to 12 possible sources of input to some operand. FIG. 8 illustrates an exemplary operand multiplexing (“muxing”) mechanism that enables rich sharing of operands within the pipeline. The mechanism shown in FIG. 8 is distributed throughout pipe control unit 401 as described below. The operand multiplexor mechanism of FIG. 8 produces three choices (e.g., IFU_SRC1, IFU_SRC2, IFU_SRC3) for the source operands provided to the first execution stage 507. Each execution stage produces a result (labeled EXE_1, EXE_2, and EXE_3 in FIG. 8) that may be used as a source operand input to the first execution stage 507. Execution stage 507 is associated with a multiplexors 809a-809c for selecting up to three source operands from those available. The specific examples given herein are for purposes of explanation and understanding, and are not a limitation on the actual implementation.

It should also be understood that execution stage 507, 509 and 511 shown in FIG. 8 are representative of all of the hardware resources used in that execution stage as defined by the processor microarchitecture. An execution stage is physically implemented using the hardware resources such as those shown in FIG. 3. The outputs of multiplexors 809 are physically coupled to each of the hardware resources that will use the source operands during its operation.

The multiplexing of these operand sources in the particular example is distributed in the following way:

The program counter (PC), instruction address registers, and control register contents are premuxed in the branch unit using multiplexors 801 and 803. All these inputs are available at the start of the cycle.

The decode constant extracted from the instruction and possibly tied high zeroes are pre-muxed in the decode stage using multiplexor 811.

The outputs of the pipefile 409 are muxed with the program counter data and decode constant data respectively in multiplexors 805 and 813.

The register file contents are muxed with the pipefile outputs using multiplexors 807, 815, and 821 to produce source operands which are distributed down the execution datapath (IFU_SRC1, IFU_SRC2, IFU_SRC3 in FIG. 8).

Forwarding of completing results is done locally within the execution datapath as suggested by the connection from the output of EXE_3 stage to the input of multiplexor 809. As the result is being driven back up the datapath from the various stages of execution (imu_result_ex1, _ex2 and _ex3), the result taps back into the multiplexor 809 latch at the input to the execution sub-units. The result is also driven back up to the pipefile for ultimate storage in the register file. Pipe control unit 401 controls the selection of the multiplexor 809 latches.

The LSU ex3 result is muxed with the output of the IMU ex3 result (from the multiplier). This is also controlled by the pipe control unit 401.

In this manner, pipe control unit 401 generates the control signals for multiplexors and execution stage resources. This enables the source operand inputs used by each execution stage to be selected from among a plurality of possible inputs. Of particular significance is that each source operand can be forwarded from the interim results stored in the pipefile if valid results are available in the pipefile. This is useful in handling data hazards in a manner that limits the need to stall the pipeline or fill the pipeline with bubbles while data dependencies resolve. The particular choice and distribution of operand sources can include more or fewer sources to meet the needs of a particular application and unless specified otherwise herein the examples are provided for example purposes only.

Moreover, some instructions may take advantage of internal forwarding within the execution resources such as IMU 305. These instructions are identified in snapshot register 701 using the IMU_MAC field and use internal forwarding data path suggested by forwarding path 810 in FIG. 8. Although for most instructions execution units 509 and 511 only receive results from earlier execution stages, instructions within this “internal forwarding” class are provided internally forwarded results via forwarding path 810. For this class of instruction, the source operand can be taken from the result output of execution unit 511. This is particularly useful for accumulate-type operations where the destination register is used in a series of instructions to hold an accumulating result. Without this feature, pipeline bubbles would likely be inserted between accumulate instructions thereby reducing throughput significantly. Using this feature, the decoder can issue accumulating type instructions one-after-another. An internal forwarding path 810 within IMU 305 can be used to forward accumulated results directly to other execution units to improve performance of multiply-accumulate and other accumulate type instructions.

While the invention has been particularly shown and described with reference to a preferred embodiment thereof, it will be understood by those skills in the art that various other changes in the form and details may be made without departing from the spirit and scope of the invention. The various embodiments have been described using hardware examples, but the present invention can be readily implemented in software. For example, it is contemplated that a programmable logic device, hardware emulator, software simulator, or the like of sufficient complexity could implement the present invention as a computer program product including a computer usable medium having computer readable code embodied therein to perform precise architectural update in an emulated or simulated out-of-order machine. Accordingly, these and other variations are equivalent to the specific implementations and embodiments described herein.

What is claimed is:

1. A data processing system comprising:
a memory system;
a plurality of peripheral components;
a processor coupled to the memory and peripheral components, the processor further comprising:
a plurality of pipeline stages, each stage configured to perform specific operations according to instructions then associated with that stage; and
a snapshot register associated with at least some of the pipeline stages, the snapshot register configured to store metadata describing the state of execution of the instruction then associated with that stage.

2. The data processing system of claim 1 further comprising a pipe control unit coupled to control each of the plurality of pipeline stages, wherein the pipe control unit coupled to communicate with the snapshot register and uses the stored metadata in the control of the pipeline stages.

3. The data processing system of claim 2 wherein each pipeline stage is configured so that the manner in which the specific operations are performed is determined in part by the contents of the snapshot registers.

4. The data processing system of claim 1 wherein the pipeline stages comprise execution pipeline stages and non-execution pipeline stages and only the execution pipeline stages have associated snapshot registers.

5. The data processing system of claim 4 wherein the execution pipeline stages include three execution pipeline stages, each producing an interim result, and one write back pipeline stage producing a final result.

6. The data processing system of claim 1 wherein at least some pipeline stages produce interim results according to the specific operations performed by those pipeline stages, and the snapshot register includes an entry indicating at which stage the interim result can be made available to other pipeline stages.

7. The data processing system of claim 6 further comprising a pipefile coupled to the pipeline stages to temporarily store the interim results.

8. The data processing system of claim 7 wherein the interim results are made available to other pipeline stages through the pipefile.

9. The data processing system of claim 1 wherein at least some of the pipeline stages are execution pipeline stages accepting operands as inputs and producing a result as an output, the system further comprising:
an operand bus coupling to the operand inputs and results outputs of each of the execution pipeline stages; and
a forwarding mechanism for passing operands between the execution pipeline stages in response to contents of the snapshot registers.

10. The data processing system of claim 1 wherein at least one pipeline stage is a write back pipeline stage that performs to update architectural state of the processor, the write back pipeline stage being responsive to the contents of the snapshot register to prevent architectural update when the snapshot register indicates an exception has been associated with the instruction within the write back pipeline stage.

11. A data processor comprising:
a plurality of pipeline stages, each stage configured to perform specific operations according to instructions then associated with that stage; and
a snapshot register associated with at least some of the pipeline stages, the snapshot register configured to store metadata describing the state of execution of the instruction then associated with that stage.

12. The data processor of claim 11 wherein the snapshot register includes an entry indicating which pipeline stage the instruction is in.

13. The data processor of claim 11 wherein the snapshot register includes an entry indicating which destination register the associated instruction with write to.

14. The data processor of claim 11 wherein the snapshot register includes an entry indicating whether a destination will be written by the associated instruction.

15. The data processor of claim 11 wherein the snapshot register includes an entry indicating that the destination register of the associated instruction is a control register.

16. The data processor of claim 11 wherein the snapshot register includes an entry indicating which pipeline stage will generate an interim result.

17. The data processor of claim 11 wherein the snapshot register includes an entry indicating whether the associated instruction is of a class that requires special performance from any of the pipeline stages.

18. The data processor of claim 11 wherein the snapshot register includes an entry indicating whether the associated instruction has been associated with an exception condition.

19. The data processor of claim 11 wherein the snapshot register includes an entry indicating whether the associated instruction has been associated with an invalidating condition.

20. The data processor of claim 11 wherein the snapshot register includes:
a first entry indicating whether the associated instruction has been associated with an exception condition;
a second entry indicating whether the associated instruction has been associated with an invalidating condition,
wherein the first and second entry are dynamically alterable by the pipeline stages.

21. A method of operating a data processor comprising:
providing an execution pipeline having a plurality of stages, each stage having a plurality of operational modes;
for each stage, storing instruction metadata in a snapshot register, the instruction metadata describing an instruction within the associated stage;
making the snapshot register contents for each stage visible to a centralized control unit, wherein the centralized control unit controls operation of a number of pipeline stages;
during operation of one of the pipeline stages, accessing one of the snapshot registers to view the instruction metadata; and
determining the operational mode of the accessing pipeline stage based upon the contents of the snapshot register.

22. The method of claim 21 wherein the accessing pipeline stage comprises an execution stage accepting a plurality of operands and generating a result and the step of determining operational mode comprises selecting a source for each of the operands.

23. The method of claim 20 wherein the accessing pipeline stage comprises a decoder stage performing dependency checking before passing an instruction to subsequent pipeline stages, wherein the step of determining operational mode comprises selecting whether to issue an instruction or stall instruction issue.
